(19) United States
(12) Patent Application Publication
(10) Pub. No.: US 2008/0278669 A1
(43) Pub. Date: Nov. 13, 2008

(54) TWISTED NEMATIC LIQUID CRYSTAL DISPLAY STRUCTURE

(75) Inventors: Cheng Chia HUANG, Shanhua (TW); Wen-Hao CHAN, Shanhua (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: SUMIKA TECHNOLOGY INC., Shanhua (TW)

(21) Appl. No.: 11/965,395

(22) Filed: Dec. 27, 2007

(30) Foreign Application Priority Data
Dec. 29, 2006 (TW) 095223191

(51) Int. Cl. G02F 1/13363

(52) U.S. Cl. 349/119

(57) ABSTRACT

A twisted nematic liquid crystal display (TN-LCD) structure is provided, which includes a twisted nematic (TN) liquid crystal layer, a first laminated polarizing film, and a second laminated polarizing film. The first laminated polarizing film and the second laminated polarizing film are respectively disposed on a first side and a second side of the TN liquid crystal layer. By means of an angle formed between a first absorption axis of a first linear polarizing film for the first laminated polarizing film and a second absorption axis of a second linear polarizing film for the second laminated polarizing film, the LCD structure of the present invention has the efficacy of an enlarged view angle, improved contrast, and low cost.

### BACKGROUND OF THE INVENTION

1. Field of the Invention

The present invention relates to a liquid crystal display (LCD) structure, and more particularly to a twisted nematic liquid crystal display (TN-LCD) structure.

2. Description of the Related Art

In recent years, LCDs having the advantage of being light, small, and thin have been widely used in mobile phones, TV sets, notebook displays, and desktop displays. However, LCDs have poor display effect at large view angle, which has always been an important issue to be resolved in the industrial and academic fields.

The liquid crystal alignment techniques of a liquid crystal layer mainly include the three following types: vertical alignment (VA), twisted nematic (TN), and in-place-switching (IPS). Relevant techniques derived from the above three include multi-domain vertical alignment (MVA), patterned vertical alignment (PVA), electrically controlled birefringence (ECB), super twisted nematic (STN), optically compensated bend mode (OCB), and so on.

FIG. 1 shows a first conventional polarizing LCD structure 1, which includes two laminated phase difference film polarizing structures 11 and a liquid crystal layer 12. Each laminated phase difference film polarizing structure 11 sequentially includes a first protective film 111, a linear polarizing film 112, and a second protective film 113. The laminated phase difference film polarizing structures 11 are symmetrically disposed on two sides of the liquid crystal layer 12. The first conventional polarizing LCD structure 1 lacks phase compensation in the thickness direction, which results in the defects of a small visible view angle, low contrast, and severe chromatic aberrations at large view angle.

FIG. 2 shows a second conventional polarizing LCD structure 2, which includes two laminated phase difference film polarizing structures 21 and a liquid crystal layer 22. Each laminated phase difference film polarizing structure 21 sequentially includes a negative c-plate negative uniaxial stretching film 211, a first protective film 212, a linear polarizing film 213, and a second protective film 214. The negative c-plate negative uniaxial stretching films 211 of the laminated phase difference film polarizing structures 21 are disposed close to two sides of the liquid crystal layer 22.

In the second conventional polarizing LCD structure 2, although the negative c-plate negative uniaxial stretching film 211 may be used to compensate the phase difference generated when viewed from a side, the view angle cannot be effectively enlarged, and the negative c-plate negative uniaxial stretching film 211 also has its own defects because it is costly and difficult to manufacture, and the uniformity of its quality cannot be easily controlled, which still leaves much room for improvement.

FIG. 3 shows a third conventional polarizing LCD structure 3, which includes two laminated phase difference film polarizing structures 31 and a liquid crystal layer 32. Each laminated phase difference film polarizing structure 31 includes a c-plate polarizing structure 311, and an o-plate polarizing structure 312. The c-plate polarizing structure 311 is disposed on a surface of the o-plate polarizing structure 312. The o-plate polarizing structures 312 of the laminated phase difference film polarizing structures 31 are disposed close to the two sides of the liquid crystal layer 32.

Through combination of the c-plate polarizing structure 311 and the o-plate polarizing structure 312, the third conventional polarizing LCD structure 3 can enlarge the view angle and reduce the chromatic aberrations. However, the third conventional polarizing LCD structure 3 significantly increases the manufacturing cost and the overall thickness of the product.

Therefore, it is necessary to provide a novel and inventive TN-LCD structure to solve the above problems.

### SUMMARY OF THE INVENTION

The present invention provides a TN-LCD structure, which includes a TN liquid crystal layer, a first laminated polarizing film, and a second laminated polarizing film. The TN liquid crystal layer has a first side and a second side. The first laminated polarizing film is disposed on the first side and includes a first biaxial stretching phase difference film, a first linear polarizing film, and a first protective film. The first biaxial stretching phase difference film is close to the first side. The first linear polarizing film is disposed on a surface of the first biaxial stretching phase difference film and has a first absorption axis. The first protective film is disposed on a surface of the first linear polarizing film. The second laminated polarizing film is disposed on the second side and includes a second biaxial stretching phase difference film, a second linear polarizing film, and a second protective film. The second biaxial stretching phase difference film is close to the second side. The second linear polarizing film is disposed on a surface of the second biaxial stretching phase difference film and has a second absorption axis. The second protective film is disposed on a surface of the second linear polarizing film. The projections of the first absorption axis and the second absorption axis on a plane are perpendicular to each other.

The TN-LCD structure of the present invention utilizes the different angles formed between the first absorption axis of the first linear polarizing film for the first laminated polarizing film and the second absorption axis of the second linear polarizing film for the second laminated polarizing film to get different large view angle properties, so that the contrast at large view angle is significantly improved, thus enlarging the view angle and achieving excellent contrast. Furthermore, the manufacturing process of the first biaxial stretching phase difference film and the second biaxial stretching phase difference film of the TN-LCD structure of the present invention is more stable than that of the conventional negative c-plate compensation film and has better uniformity of a large area and a lower cost.

### BRIEF DESCRIPTION OF THE DRAWINGS

FIG. 1 is a schematic view of a first conventional polarizing LCD structure;

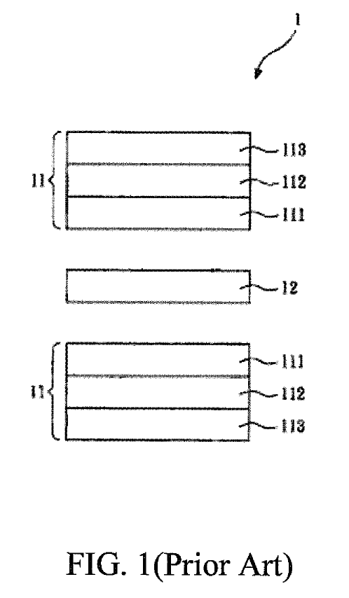

FIG. 2 is a schematic view of a second conventional polarizing LCD structure;

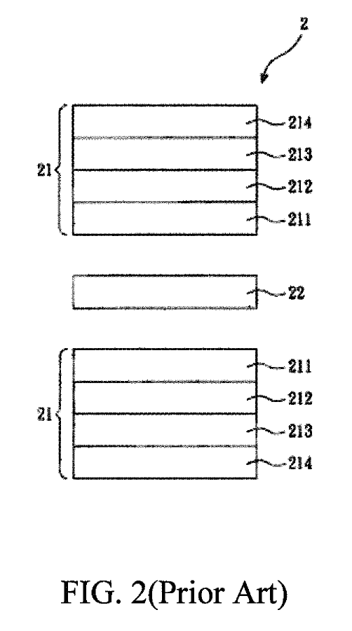

FIG. 3 is a schematic view of a third conventional polarizing LCD structure;

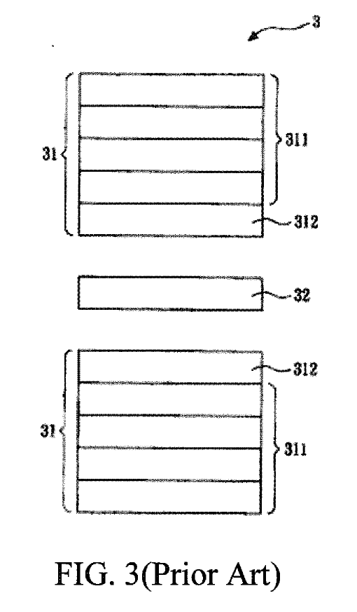

FIG. 4 is a schematic view of a TN-LCD structure according to the present invention;

FIG. 5 is a contrast/view angle diagram of a first TN-LCD structure according to the present invention;

FIG. 6 is a contrast/view angle diagram of a second TN-LCD structure according to the present invention; and FIG. 7 is a contrast/view angle diagram of a conventional polarizing LCD structure.

### DETAILED DESCRIPTION OF THE INVENTION

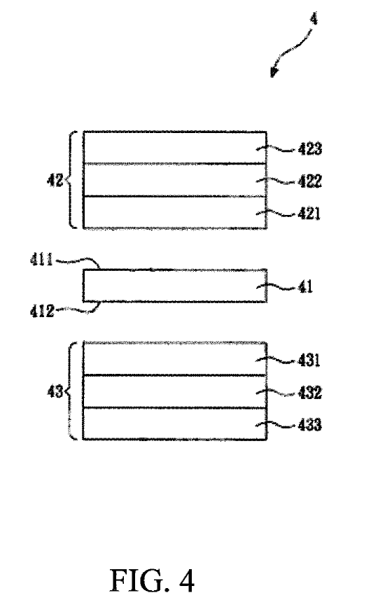

As shown in FIG. 4, a TN-LCD structure 4 of the present invention includes a TN liquid crystal layer 41, a first laminated polarizing film 42, and a second laminated polarizing film 43. The liquid crystal alignment technique of the TN liquid crystal layer 41 may be twisted nematic (TN) technique or super twisted nematic (STN) technique. The TN liquid crystal layer 41 has a first side 411 and a second side 412.

The first laminated polarizing film 42 is disposed on the first side 411, and the second laminated polarizing film 43 is disposed on the second side 412. Depending upon different applications, the first side 411 is a side of a color filter for the LCD, and the second side 412 is a side of a thin film transistor for the LCD, or the first side 411 is a side of a thin film transistor for the LCD, and the second side 412 is a side of a color filter for the LCD.

The first laminated polarizing film 42 includes a first biaxial stretching phase difference film 421, a first linear polarizing film 422, and a first protective film 423. The first biaxial stretching phase difference film 421 is close to the first side 411. The first linear polarizing film 422 is disposed on a surface of the first biaxial stretching phase difference film 421 and has a first absorption axis. The first protective film 423 is disposed on a surface of the first linear polarizing film 422 for protecting the first linear polarizing film 422.

The second laminated polarizing film 43 includes a second biaxial stretching phase difference film 431, a second linear polarizing film 432, and a second protective film 433. The second biaxial stretching phase difference film 431 is close to the second side 412. The second linear polarizing film 432 is disposed on a surface of the second biaxial stretching phase difference film 431 and has a second absorption axis. The second protective film 433 is disposed on a surface of the second linear polarizing film 432. The second biaxial stretching phase difference film 431 and the second protective film 433 are used to protect the second linear polarizing film 432.

It should be noted that the first absorption axis of the first linear polarizing film 422 may form any angle with a side edge of the TN liquid crystal layer 41, and when the projections of the first absorption axis of the first linear polarizing film 422 and the second absorption axis of the second linear polarizing film 432 on a plane are perpendicular to each other, it achieves the best contrast. Alternatively, the second absorption axis of the second linear polarizing film 432 may form any angle with a side edge of the TN liquid crystal layer 41, and the projections of the first absorption axis of the first linear polarizing film 422 and the second absorption axis of the second linear polarizing film 432 on a plane are perpendicular to each other.

The first biaxial stretching phase difference film 421 and the second biaxial stretching phase difference film 431 have the same structure. Take the first biaxial stretching phase difference film 421 as an example: the first biaxial stretching phase difference film 421 has a slow axis, and the slow axis is perpendicular to the first absorption axis of the first linear polarizing film 422 or the second absorption axis of the second linear polarizing film 432. Furthermore, the first biaxial stretching phase difference film 421 may be an equivalent biaxial stretching phase difference film formed by at least one phase difference film.

In this embodiment, the first biaxial stretching phase difference film 421 has a first horizontal refraction index and a second horizontal refraction index. In this embodiment, the first horizontal refraction index is a slow axis refraction index in the horizontal direction, and the second horizontal refraction index is a fast axis refraction index in the horizontal direction. The first biaxial stretching phase difference film 421 has a phase difference value in the thickness direction, and the phase difference value in the thickness direction (Rth) is defined as ((nx+ny)/2−nz)*d, in which nx indicates the slow axis refraction index in horizontal direction, ny indicates the fast axis refraction index in horizontal direction, nz indicates a refraction index in thickness direction, and d indicates a thickness of the first biaxial stretching phase difference film 421.

In this embodiment, the refraction index in the thickness direction (nz) of the first biaxial stretching phase difference film 421 is smaller than the refraction index in the horizontal direction (nx or ny). The refraction index in the thickness direction of the first biaxial stretching phase difference film is smaller than the refraction index in the horizontal direction under the two following conditions: one is when the slow axis refraction index (nx) in the horizontal direction is equal to the fast axis refraction index (ny) in the horizontal direction, and the refraction index in the thickness direction (nz) of the first biaxial stretching phase difference film is smaller than the slow axis refraction index (nx) in the horizontal direction and the fast axis refraction index (ny) in the horizontal direction; and the other is when the slow axis refraction index (nx) in the horizontal direction is larger than the fast axis refraction index (ny) in the horizontal direction, and the fast axis refraction index (ny) in the horizontal direction is larger than the refraction index in the thickness direction (nz) of the first biaxial stretching phase difference film. Both of the above conditions can reduce the overall phase difference value in the thickness direction to enlarge the view angle. Preferably, the phase difference value in the thickness direction (Rth) of the first biaxial stretching phase difference film falls within the rage of 10 nm to 300 nm, and the phase difference value (R0) in the front-viewing direction of the first biaxial stretching phase difference film falls within the range of 30 nm to 80 nm. In this embodiment, the phase difference value in the thickness direction of the first biaxial stretching phase difference film 421 falls within the rage of 100 nm to 300 nm, and thus the first biaxial stretching phase difference film 421 has the optimal effect of the enlarged view angle.

As the TN-LCD structure 4 may decrease the phase difference value in the thickness direction, it may further decrease the absolute value of the overall phase difference value in the thickness direction. Accordingly, the TN-LCD structure 4 of the present invention can significantly increase the contrast so that the images become clearer when observed from a side, and thus, the viewers can see the images of the LCD clearly when observing from a side, thereby achieving the effect of enlarging the view angle.

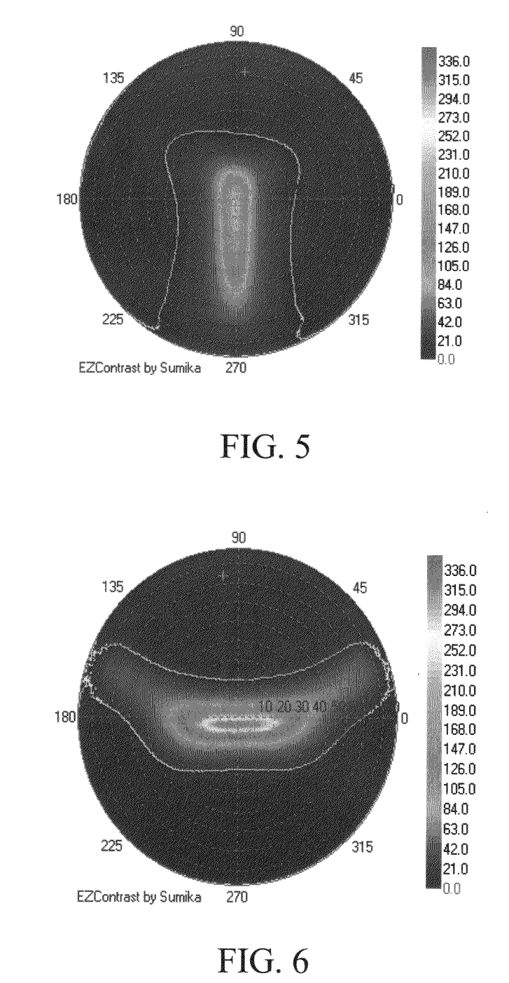

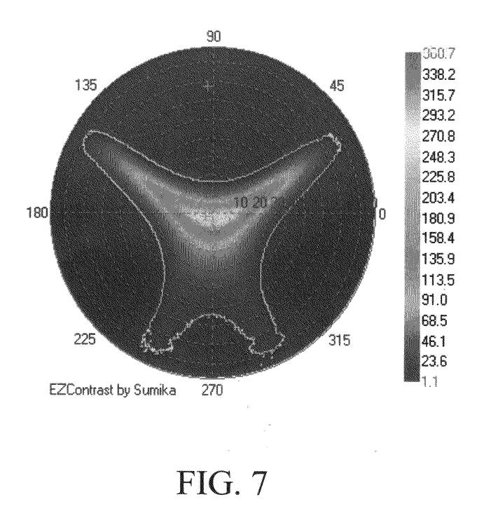

FIG. 5 is a contrast/view angle diagram of a first TN-LCD structure according to the present invention; FIG. 6 is a contrast/view angle diagram of a second TN-LCD structure according to the present invention; and FIG. 7 is a contrast/view angle diagram of a conventional polarizing LCD structure. The difference between the first TN-LCD structure of the present invention and the second TN-LCD structure of the present invention lies in that the first absorption axis of the first linear polarizing film for the first laminated polarizing film and the second absorption axis of the second linear polarizing film for the second laminated polarizing film have different orientations and form different angles with respect to the surface of the TN liquid crystal layer, thus generating different contrast/view angle diagrams.

A comparison of FIGS. 5 and 7 shows that the TN-LCD structure 4 of the present invention has a better view angle at the lower part than the conventional polarizing LCD structure. Therefore, if the better direction of the view angle is applied to a display panel (such as in a mobile phone) and designed as a downward view angle of the display panel, the display panel will have a relatively large view angle.

As can be clearly seen from the comparison of FIGS. 6 and 7, the TN-LCD structure 4 of the present invention is much better than the convention polarizing LCD structure in terms of the contrast and view angle on the left and right sides. Therefore, the TN-LCD structure 4 of the present invention has the efficacy of significantly improving the contrast value of the view angle and enlarging the view angle.

The TN-LCD structure 4 of the present invention utilizes different angles formed between the first absorption axis of the first linear polarizing film 422 for the first laminated polarizing film 42 and the second absorption axis of the second linear polarizing film 432 for the second laminated polarizing film 43 to reduce the overall phase difference in the thickness direction, which significantly increases the contrast value of large view angle and enlarges the view angle, thus resulting in excellent contrast. Furthermore, the manufacturing process of the first biaxial stretching phase difference film 421 and the second biaxial stretching phase difference film 431 of the TN-LCD structure of the present invention is more stable than that of the conventional negative c-plate compensation film and has better uniformity of a large area and a lower cost.

While the embodiments of the present invention have been illustrated and described, various modifications and improvements can be made by those skilled in the art. The embodiments of the present invention are therefore described in an illustrative but not restrictive sense. It is intended that the present invention is not be limited to the particular forms illustrated, and that all modifications that maintain the spirit and scope of the present invention are within the scope defined in the appended claims.

What is claimed is:

1. A twisted nematic liquid crystal display (TN-LCD) structure, comprising:
a twisted nematic (TN) liquid crystal layer, having a first side and a second side;
a first laminated polarizing film, disposed on the first side, and comprising:
a first biaxial stretching phase difference film, close to the first side;
a first linear polarizing film, disposed on a surface of the first biaxial stretching phase difference film, and having a first absorption axis; and
a first protective film, disposed on a surface of the first linear polarizing film;
a second laminated polarizing film, disposed on the second side, and comprising:
a second biaxial stretching phase difference film, close to the second side;
a second linear polarizing film, disposed on a surface of the second biaxial stretching phase difference film, and having a second absorption axis; and
a second protective film, disposed on a surface of the second linear polarizing film;
wherein projections of the first absorption axis and the second absorption axis on a plane are perpendicular to each other.

2. The LCD structure according to claim 1, wherein the first side is a side of a color filter for a liquid crystal display, and the second side is a side of a thin film transistor for the liquid crystal display.

3. The LCD structure according to claim 1, wherein the first side is a side of a thin film transistor for a liquid crystal display, and the second side is a side of a color filter for the liquid crystal display.

4. The LCD structure according to claim 1, wherein a liquid crystal alignment technique of the TN liquid crystal layer is twisted nematic (TN) technique or super twisted nematic (STN) technique.

5. The LCD structure according to claim 1, wherein the first biaxial stretching phase difference film and the second biaxial stretching phase difference film has a first horizontal refraction index and a second horizontal refraction index, the first horizontal refraction index being larger than the second horizontal refraction index, and the second horizontal refraction index being larger than a refraction index in the thickness directions of the first biaxial stretching phase difference film and the second biaxial stretching phase difference film.

6. The LCD structure according to claim 1, wherein the first biaxial stretching phase difference film and the second biaxial stretching phase difference film has a first horizontal refraction index and a second horizontal refraction index, the first horizontal refraction index being equal to the second horizontal refraction index, and a refraction index in thickness directions of the first biaxial stretching phase difference film and the second biaxial stretching phase difference film being smaller than the first horizontal refraction index and the second horizontal refraction index.

7. The LCD structure according to claim 1, wherein the first absorption axis forms any angle with a side edge of the TN liquid crystal layer, and the projections of the first absorption axis and the second absorption axis on the plane are perpendicular to each other.

8. The LCD structure according to claim 1, wherein the second absorption axis forms any angle with a side edge of the TN liquid crystal layer, and the projections of the first absorption axis and the second absorption axis on the plane are perpendicular to each other.

9. The LCD structure according to claim 1, wherein the first biaxial stretching phase difference film and the second biaxial stretching phase difference film each has a slow axis, and the slow axes are perpendicular to the first absorption axis of the first linear polarizing film or the second absorption axis of the second linear polarizing film.

10. The LCD structure according to claim 1, wherein a phase difference value of the first biaxial stretching phase difference film and the second biaxial stretching phase difference film in a front-viewing direction falls within the range of 30 nm to 80 nm, and the phase difference value of the first biaxial stretching phase difference film and the second biaxial stretching phase difference film in a thickness direction falls within the range of 10 nm to 300 nm.

11. The LCD structure according to claim 10, wherein the phase difference value of the first biaxial stretching phase difference film and the second biaxial stretching phase difference film in the thickness direction falls within the range of 100 nm to 300 nm.

12. The LCD structure according to claim 1, wherein the first biaxial stretching phase difference film and the second biaxial stretching phase difference film are equivalent biaxial stretching phase difference films respectively formed by at least one phase difference film.
